(19) United States
(12) Patent Application Publication
(10) Pub. No.: US 2026/0358193 A1
(43) Pub. Date: Nov. 12, 2026

(54) OPTICAL CHARACTERIZATION OF EXPANDED BEAM FIBER OPTIC CONNECTORS

(71) Applicant: CORNING RESEARCH & DEVELOPMENT CORPORATION, CORNING, NY (US)

(72) Inventors: Jakub Wojciech Krawczyk, Dobieszków (PL); Piotr Michal Szewczyk, Lódz (PL)

(21) Appl. No.: 19/550,940

(22) Filed: Feb. 26, 2026

Related U.S. Application Data
(60) Provisional application No. 63/801,952, filed on May 8, 2025.

(51) Int. Cl. G01M 11/00; G02B 6/44

(52) U.S. Cl. CPC G01M 11/33; G02B 6/4453

(57) ABSTRACT

A system, method, and connector for testing optical links including an expanded beam connector. The system includes an expanded beam connector adapter and a modified expanded beam connector. The adapter includes a body and a coupler. The body includes a connector cavity configured to receive expanded beam connectors and an optical port that intersects the connector cavity at an angle such that an optical beam emitted laterally from the expanded beam connector passes through the optical port. The coupler is configured to couple the expanded beam connector adapter to a power meter so that the optical port of the body is aligned with an optical port of the power meter. The modified expanded beam connector includes a ferrule and a cassette. The cassette includes an optical window through which the optical beam emitted laterally from the ferrule passes when the expanded beam connector is engaged with the connector cavity.

### PRIORITY CLAIM

This application claims the benefit of priority of U.S. Provisional Patent Application Serial No. 63/801,952 filed on May 8, 2025, the content of which is relied upon and incorporated herein by reference in its entirety.

### TECHNICAL FIELD

This disclosure relates generally to optical connectivity, and more particularly to a method of testing expanded beam fiber optic connectors.

### BACKGROUND

Optical fibers are useful in a wide variety of applications, including the telecommunications industry for voice, video, and data transmissions. Benefits of optical fibers include wide bandwidth and low noise operation. In a telecommunications system that uses optical fibers, there are typically many locations where fiber optic cables containing optical fibers connect to equipment or other fiber optic cables. To conveniently provide these connections, fiber optic connectors are often provided on the ends of fiber optic cables to non-permanently connect and disconnect optical elements in the fiber optic network.

The large growth of the Internet has increased the demand for data centers to organize, process, store, and disseminate large amounts of data. Data centers contain information technology equipment that supports these activities, such as servers, networking switches, routers, storage systems, etc. Data centers further include a large amount of cabling and racks to organize and interconnect this equipment. Connections are often made between various ports of patch panels using connectorized fiber optic cables (e.g., prefabricated patch cords) that include a length of fiber optic cable terminated at each end with a connector. The connectors of a connectorized fiber optic cable can then be inserted into certain ports in designated patch panels to achieve a desired connection between the information technology equipment.

One negative consequence of using connectorized fiber optic cables is the potential for the introduction of excessive insertion loss of optical signals across the optical connection, e.g., at the junction between optical fibers. The insertion losses in coupling two optical fibers across an optical connection are generally a function of the alignment of the optical fiber ends, the width of the gap between the ends, and the optical surface condition at the ends. If any of these parameters is out of specification (e.g., due to a defective connector), the connectorized fiber optic cable may introduce excessive insertion loss into the optical link. Defects in the fiber optic cable itself can also lead to excessive insertion loss.

In order to prevent the occurrence of excessive insertion loss in the field, connectorized fiber optic cables may be tested for insertion loss by the manufacturer as part of a quality control process. Insertion loss testing may be performed by connecting a reference cable on one end of the connectorized fiber optic cable to a light source, connecting the other to an optical power meter, and measuring the amount of light received by the power meter. The amount of light measured with the cable under test can then be compared to the amount of light coming out of the reference cable. If the amount of light transmitted by the cable under test is less than the reference amount of light by more than a maximum allowable threshold, the cable may be failed.

Fiber optic connectors may be classified as physical contact fiber optic connectors or expanded beam fiber optic connectors. Physical contact fiber optic connectors (“physical contact connectors”) bring the end faces of the optical fibers being connected into physical contact so that light is coupled directly from one optical fiber into the other optical fiber. Expanded beam fiber optic connectors (“expanded beam connectors”) use optical devices to expand the light beam transmitted from the transmitting optical fiber and refocus the expanded beam onto the receiving optical fiber. To provide this feature, each expanded beam connector includes an optical device (e.g., a lens or reflective surface) that expands the optical beam transmitted to the other connector, and focuses the expanded optical beam received from the other connector.

Due in part to their lower cost, physical contact connectors are used far more commonly than expanded beam connectors. However, expanded beam connectors have certain advantages over physical contact connectors. For example, due to the larger cross-sectional width of the expanded beam, expanded beam connectors tend to be more tolerant of misalignment and dirt in the optical path than physical contact connectors. This tolerance to dirt and misalignment can make expanded beam connectors the preferred connector for harsh environments. The lack of physical contact between the optical fibers being coupled also reduces the likelihood of wear or damage occurring to the end faces of the optical fibers. This characteristic can make expanded beam connectors the preferred type for applications where the connector will be subjected to frequent mating cycles.

Expanded beam connectors differ in significant ways from standard physical contact connectors. These differences create unique measurement requirements when testing fiber optic cables terminated with one or more expanded beam connectors. These unique measurement requirements make expanded beam connectors incompatible with systems and methods used for measuring the insertion loss of physical contact connectors. This, coupled with the relatively low use of physical contact connectors in the field, has led to a lack of equipment and methods for testing insertion loss across optical links that include expanded beam connectors.

Thus, there is a need in the fiber optic industry for improved systems and methods of measuring the optical performance of expanded beam connectors. More particularly, there is a need for systems and methods of measuring the insertion loss of fiber optic cables including expanded beam connectors that address the unique challenges associated therewith.

### SUMMARY

In one aspect of the disclosure, an improved system for testing optical links including an expanded beam connector is disclosed. The system includes an expanded beam connector adapter and a coupler. The expanded beam connector adapter includes a body having a connector cavity configured to receive the expanded beam connector and an optical port that intersects the connector cavity. The optical port intersects the connector cavity at an angle such that, when the expanded beam connector is engaged with the connector cavity, an optical beam emitted laterally from the expanded beam connector passes through the optical port. The coupler is configured to couple the expanded beam connector adapter to a power meter so that the optical port of the body is aligned with the optical port of the power meter.

In one embodiment of the disclosed system, the system may further include a fitting configured to receive the expanded beam connector, and the fitting may be removably inserted into the connector cavity.

In another embodiment of the disclosed system, the system may further include a retainer configured to engage the body of the expanded beam connector adapter and retain the fitting in the connector cavity.

In another embodiment of the disclosed system, the system may further include an indexing plunger assembly operatively coupled to the body of the expanded beam connector adapter and configured to selectively engage the power meter. The indexing plunger assembly may prevent rotation of the expanded beam connector adapter relative to the power meter when it is engaged, and may allow rotation of the expanded beam connector adapter relative to the power meter when it is not engaged.

In another embodiment of the disclosed system, the system may further include an imaging screen. The imaging screen may be positioned in the body of the expanded beam connector adapter so that, when the expanded beam connector is engaged with the connector cavity, at least a portion of the imaging screen is both visible through the optical port of the body and in an optical path of the optical beam emitted from the expanded beam connector.

In another embodiment of the disclosed system, the imaging screen may include one or more of an optical diffuser, a lens, and a filter.

In another embodiment of the disclosed system, the expanded beam connector may include a ferrule that emits the optical beam and a cassette that positions the ferrule within the expanded beam connector. The cassette may include an optical window through which the optical beam passes when the expanded beam connector is engaged with the connector cavity.

In another embodiment of the disclosed system, the system may further include a light source. In this embodiment, the expanded beam connector may terminate a fiber optic cable that is operatively coupled to the light source.

In another embodiment of the disclosed system, the system may further include a reference fiber optic cable assembly that includes the expanded beam connector.

In another embodiment of the disclosed system, the expanded beam connector may be a first expanded beam connector operatively coupled to the power meter by the expanded beam connector adapter, and the reference fiber optic cable assembly may include a second expanded beam connector. In this embodiment, the system may further include an optical link under test that operatively couples a light source to the second expanded beam connector of the reference fiber optic cable assembly.

In another aspect of the disclosure, an improved method of testing optical links including an expanded beam connector is disclosed. The method includes providing the expanded beam connector adapter including the connector cavity and the optical port, configuring the connector cavity to receive the expanded beam connector, and configuring the optical port to intersect the connector cavity. The optical port intersects the connector cavity at the angle such that, when the expanded beam connector is engaged with the connector cavity, the optical beam emitted laterally from the expanded beam connector passes through the optical port.

In one embodiment of the disclosed method, configuring the connector cavity to receive the expanded beam connector may include configuring the fitting to receive the expanded beam connector, and inserting the fitting into the connector cavity.

In another embodiment of the disclosed method, the method may further include retaining the fitting in the connector cavity by engaging the retainer with the body of the expanded beam connector adapter.

In another embodiment of the disclosed method, the method may further include operatively coupling the indexing plunger assembly to the body of the expanded beam connector adapter, and configuring the indexing plunger assembly to selectively engage the power meter to prevent rotation of the expanded beam connector adapter relative to the power meter when engaged and allow rotation of the expanded beam connector adapter relative to the power meter when not engaged.

In another embodiment of the disclosed method, the method may further include positioning the imaging screen in the body of the expanded beam connector adapter so that, when the expanded beam connector is engaged with the connector cavity, at least a portion of the imaging screen is both visible through the optical port and in the optical path of the optical beam emitted from the expanded beam connector.

In another embodiment of the disclosed method, the imaging screen may include one or more of the optical diffuser, the lens, and the filter.

In another embodiment of the disclosed method, the method may further include terminating one end of the fiber optic cable with the expanded beam connector, and operatively coupling the other end of the fiber optic cable to the light source.

In another embodiment of the disclosed method, the method may further include terminating one end of the reference fiber optic cable assembly with the expanded beam connector.

In another embodiment of the disclosed method, the expanded beam connector may be the first expanded beam connector. In this embodiment, the method may further include operatively coupling the first expanded beam connector to the power meter with the expanded beam connector adapter, terminating the other end of the reference fiber optic cable assembly with the second expanded beam connector, and operatively coupling one side of the optical link under test to the light source and the other side of the optical link under test to the second expanded beam connector of the reference fiber optic cable assembly.

In another aspect of the disclosure, an improved expanded beam connector is disclosed. The connector includes a body, the ferrule, and the cassette. The ferrule emits the optical beam laterally therefrom. The cassette positions the ferrule within the body and includes the optical window through which the optical beam passes when the connector is not engaged with another connector.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a cross-sectional view of an exemplary expanded beam connector including a ferrule.

FIG. 2 is a cross-sectional view of a mated pair of the expanded beam connectors of FIG. 1 showing engagement of the ferrules.

FIG. 3 is a cross-sectional view of the mated ferrules of FIG. 2 showing the optical path of an optical beam propagating between two optical fibers operatively coupled to the ferrules.

FIG. 4 is a schematic view of an exemplary baseline test setup including a light source and a power meter for characterizing an optical link including expanded beam connectors such as depicted by FIGS. 1-3.

FIG. 5 is a schematic view of an exemplary single-ended test setup including the baseline test setup of FIG. 4 with the addition of a reference fiber optic cable assembly into the optical link.

FIG. 6 is a schematic view of an exemplary double-ended test setup including the single-ended test setup of FIG. 5 with the addition of another fiber optic cable assembly into the optical link.

FIG. 7 is a schematic view of another exemplary baseline test setup including the light source and power meter of FIGS. 4-6 and an expanded beam connector adapter for characterizing another optical link including expanded beam connectors such as depicted by FIGS. 1-3.

FIG. 8 is a schematic view of another exemplary single-ended test setup including the baseline test setup of FIG. 7 with the addition of an alternative reference fiber optic cable assembly into the optical link.

FIG. 9 is a schematic view of another exemplary double-ended test setup including the single-ended test setup of FIG. 8 with the addition of another fiber optic cable assembly into the optical link.

FIG. 10 is a diagrammatic view of a process for modifying the expanded beam connector of FIGS. 1-3 for use in the test setups of FIGS. 7-9.

FIGS. 11 and 12 are cross-sectional views of an exemplary expanded beam adapter that may be used with the test setups of FIGS. 7-9.

FIG. 13 is an exploded view of the expanded beam adapter of FIGS. 11 and 12.

FIGS. 14 and 15 are cross-sectional views of another exemplary expanded beam adapter that may be used with the test setups of FIGS. 7-9.

FIG. 16 is an exploded view of the expanded beam adapter of FIGS. 14 and 15.

FIGS. 17 and 18 are cross-sectional views of another exemplary expanded beam adapter that may be used with the test setups of FIGS. 7-9.

FIG. 19 is an exploded view of the expanded beam adapter of FIGS. 17 and 18.

FIG. 20 is a diagrammatic view of an integrating sphere that may be used by the power meter of FIGS. 4-10 to measure power levels.

FIG. 21 is a diagrammatic view of a polarity detector including a camera that measures the polarity of optical signals in a connector.

FIG. 22 is a photographic view of exemplary expanded optical beams 38 captured by the camera of FIG. 21.

FIGS. 23 and 24 are photographic views comparing images of expanded optical beams and unexpanded optical beams at different exposure levels.

FIG. 25 is a cross-sectional view of an expanded beam adapter that includes an imaging screen that may be used to enhance the performance of the polarity detector of FIG. 21.

### DETAILED DESCRIPTION

Various embodiments will be further clarified by examples in the description below. In general, the description relates to systems and methods of characterizing optical links that include one or more expanded beam connectors. More specifically, the systems and methods include improved test setups in which a modified expanded beam connector is coupled to a power meter using an expanded beam optical adapter. Optical characterizations enabled by the disclosed test setups may include, but are not limited to, insertion loss, return loss, and polarization loss. The modification to the expanded beam optical connector involves adding an optical window to the connector so that an expanded optical beam emitted laterally from a ferrule of the connector is not blocked by the connector. The modified expanded beam connector and expanded beam optical adapter are configured so that the connector is positioned at an angle which enables the laterally emitted expanded optical beam to be received by the power detector. The expanded beam optical adapter thereby enables the expanded optical beam to be transmitted from the modified connector to the power detector without the need for a custom large core fiber optical cable assembly as required by known test setups.

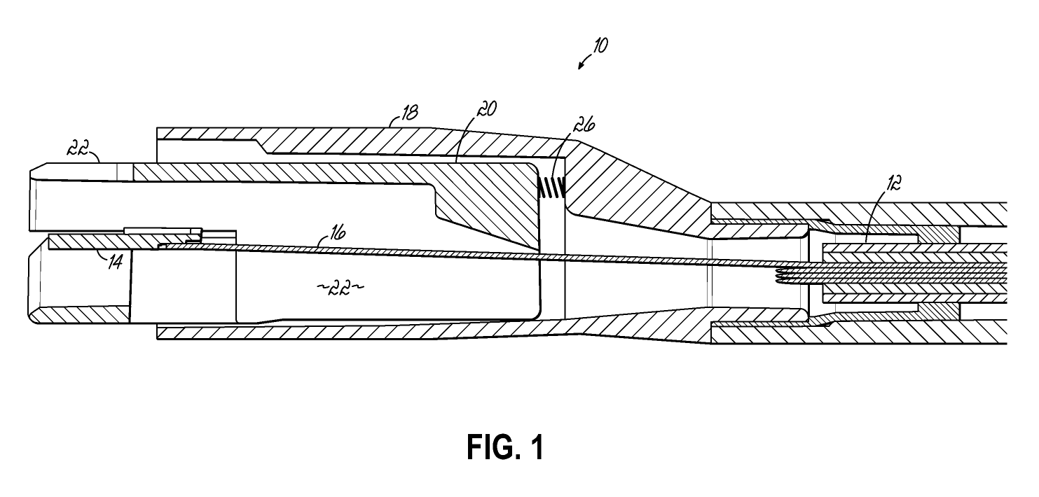

FIG. 1 depicts an exemplary expanded beam connector 10 shown terminating a fiber optic cable 12. The expanded beam connector 10 includes a ferrule 14 configured to receive one or more optical fibers 16 (e.g., 12 optical fibers) of the fiber optic cable 12, and a connector housing 18 having a cavity 20 configured to receive a cassette 22. The cassette 22 may be configured to position the ferrule 14 within the connector 10. The optical fibers 16 may be fastened to the cassette 22 by a collet or other suitable fastener (not shown). The cassette 22 may be biased to an extended position in the connector housing 18 by a spring 26 or another suitable elastic member. The cassette 22 and spring 26 may interact with the internal geometry of the connector housing 18 to allow the cassette 22 to move longitudinally within a range of motion relative to the connector housing 18.

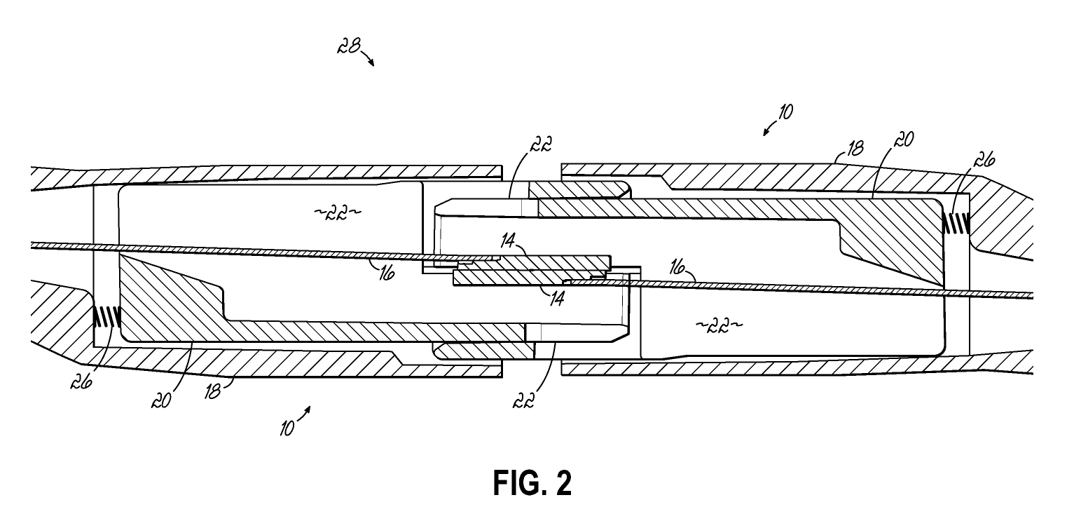

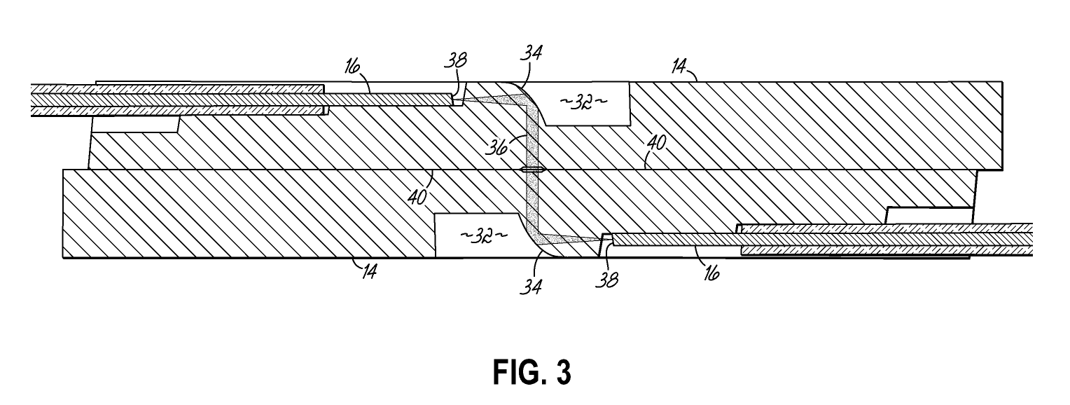

FIG. 2 depicts a mated pair 28 of the expanded beam connectors 10 depicted by FIGS. 1, and 3 depicts an enlarged view of the mated ferrules 14 of the mated pair 28 of FIG. 2. The mated pair 28 may be connected through a sleeve or other adapter (not shown) that facilitates alignment of the cassettes 22 and prevents the expanded beam connectors 10 from being pulled apart by tension on the fiber optic cables 12. The expanded beam connectors 10 may be configured so that when they are coupled to one another, the ferrules 14 thereof engage each other in a self-aligning manner so that optical beams can be transmitted between the optical fibers 16 of one expanded beam connector 10 and those of the other expanded beam connector 10.

An optical device that reduces the divergence (or increases the convergence) of an optical beam may be generally referred to as a collimator. The divergence of an optical beam may be decreased by modifying the direction of the rays of the optical beam so that they become more aligned with a specific direction, e.g., so that they become parallel or “collimated”. The convergence of the optical beam may be increased by modifying the direction of the rays of the optical beam so that they converge, e.g., so that the optical beam becomes focused. Optical devices may also be configured to change the direction of propagation of an optical beam as a whole, e.g., by modifying the direction of the rays of the optical beam so that the center axis of the optical beam is oriented in a new direction. An optical device that changes the direction of (or “redirects”) an optical beam may be generally referred to as a director. An optical device may be configured to collimate or focus an optical beam, redirect an optical beam, or both collimate/focus and redirect an optical beam. These types of optical devices may be generally referred to herein as “light modifying devices”. Light modifying devices may be configured to modify the rays of an optical beam in a desired way using ray tracing or any other suitable design technique. For example, light modifying devices having a desired set of characteristics may be designed on a computer running ray-tracing or other optical simulation software.

As best shown by FIG. 3, the body of each ferrule 14 may include an optical material having an index of refraction n₁ greater than the index of refraction n₀ of air. Each ferrule 14 may also include one or more cavities 32 in the optical material, with each cavity 32 defining one or more light modifying surfaces 34. The indexes of refraction of the optical material and the air may be sufficiently different so that light from an optical fiber 16 which is incident on the light modifying surface 34 undergoes total internal reflection. Each light modifying surface 34 may be flat, curved (as shown), or otherwise configured to reflect light incident on the surface 34 in a predetermined way. Each light modifying surface 34 may thereby define an optical element that modifies the direction of the rays of an optical beam 36 incident thereon. The one or more cavities 32 of ferrules 14 may thereby define one or more optical devices each including one or more optical elements that collectively modify the optical beam 36 emitted from one optical fiber 16 so that it is received by another optical fiber 16. An optical beam 36 emitted from the ferrule 14 at an angle less than 45 degrees relative to the optical axis of the transmitting optical fiber 16 may be referred to as an axially emitted optical beam 36. In contrast, an optical beam 36 emitted from the ferrule 14 at an angle greater than or equal to 45 degrees relative to the optical axis of the transmitting optical fiber 16 (such as depicted by FIG. 3) may be referred to as a laterally emitted optical beam 36.

In the exemplary embodiment depicted by FIG. 3, the end face 38 of each optical fiber 16 may be positioned a predetermined distance from the light modifying surface 34 that allows an optical beam 36 emitted from the end face 38 to expand to a desired beam width prior to reaching the surface 34. The light modifying surface 34 may be configured to redirect and collimate the optical beam 36 received from the transmitting optical fiber 16. The light modifying surface 34 may direct the optical path of the (now expanded) optical beam 36 towards a generally planar outer surface 40 of the ferrule 14 opposite the cavity 32. Accordingly, the expanded optical beam 36 may be emitted laterally from the ferrule 14 due to the redirection of the optical beam by the modifying surface 34. As a result of this redirection, the expanded optical beam 36 may have a direction of propagation that is offset from the optical axis of the transmitting optical fiber 16 by about 80-90 degrees, for example.

The expanded optical beam 36 may exit the originating ferrule 14 and enter the mated ferrule 14 through their respective planar outer surfaces 40. The light modifying surface 34 of the receiving ferrule 14 may redirect and focus the optical beam 36 so that it is aligned with the optical axis of and received by the end face 38 of the receiving optical fiber 16. Accordingly, when the ferrules 14 are fully engaged, an optical beam 36 emitted from any of the optical fibers 16 in one of the expanded beam connectors 10 may be optically coupled to a respective optical fiber 16 of the other expanded beam connector 10.

Redirecting the optical beam 36 so that it is emitted from the ferrule 14 laterally may provide certain advantages over axial emission. For example, a large emission angle may facilitate configuring ferrules 14 to be genderless and self-aligning. In the above depicted embodiment, lateral emission may also support a “suspended fiber” feature that lowers the required insertion force when mating connectors as compared to axial emission connector designs. Lateral emission of the optical beams 36 from the ferrule 14 may also result in the optical beams 36 being blocked by the cassette 22 of an unmated expanded beam connector 10. This and other features of laterally emitting ferrule designs may create problems with testing of fiber optic cable assemblies that do not affect axially emitting ferrule designs.

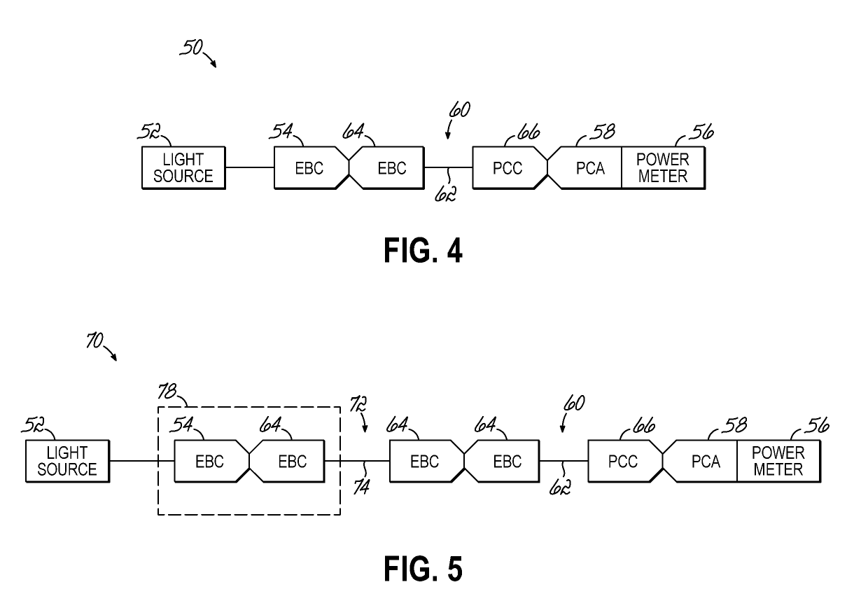

FIG. 4 depicts an exemplary baseline test setup 50 for characterizing an optical link including an expanded beam connector. The baseline test setup 50 includes a light source 52 operatively coupled to a reference expanded beam connector 54, a power meter 56 including a physical contact connector adapter 58 (e.g., an industry standard MTP/MPO connector), and a reference fiber optic cable assembly 60. The light source 52 may be configured to provide light having stable power at one or more wavelengths typically used in fiber optic networks, e.g., wavelengths between 1260 nm and 1675 nm. The reference expanded beam connector 54 may be operatively coupled to the output of the light source 52 (e.g., by a fiber optic cable including one or more optical fibers) so that the light from the light source 52 can be coupled into an optical link under test. The reference expanded beam connector 54 may terminate the one or more optical fibers (e.g., 12 or 16 optical fibers – not shown), and the light source 52 may be configured to selectively provide light to each of the one or more optical fibers. By way of example, the light source 52 may include an optical switching feature that sequentially provides light to each of the optical fibers terminated by the reference expanded beam connector 54 so that optical characteristics can be measured individually for each optical fiber.

The power meter 56 may include a detector (e.g., an internal detector or a remote head detector – not shown) that is operatively coupled to the physical contact connector adapter 58. The reference fiber optic cable assembly 60 may include a fiber optic cable 62 including one or more large core optical fibers (e.g., 62.5 μm multi-mode optical fibers) that are terminated at one end by an expanded beam connector 64 and at the other end by a standard physical contact fiber optic connector 66 configured to mate with the physical contact connector adapter 58 of power meter 56. In operation, the baseline test setup 50 may be used to measure a baseline characteristic (e.g., baseline insertion loss) between the light source 52 and power meter 56. As described in more detail below, this baseline characteristic may be used to determine a related characteristic (e.g., link insertion loss) of an optical link under test, e.g., a fiber optic connector, a fiber optic cable assembly, or a combination of one or more fiber optic connectors and cable assemblies. For reasons of clarity and brevity, the test setups disclosed below may be described in terms of a specific type of optical characterization, such as insertion loss. However, it should be understood that embodiments of the disclosed test setups are not limited to a specific type of optical characterization, and may be used for determining various characteristics of an optical link.

FIG. 5 depicts an exemplary single-ended test setup 70 that includes the components of the baseline test setup 50 with the addition of another fiber optic cable assembly 72. The fiber optic cable assembly 72 may include a fiber optic cable 74 that is terminated at each end by a respective expanded beam connector 64. The fiber optic cable assembly 72 may be inserted between the reference expanded beam connector 54 and the expanded beam connector 64 of reference fiber optic cable assembly 60. The characteristic of the optical link 78 may then be determined by measuring the test characteristic between the light source 52 and power meter 56, and comparing the test characteristic to the baseline characteristic. This comparison may include, for example, subtracting the baseline characteristic from the test characteristic.

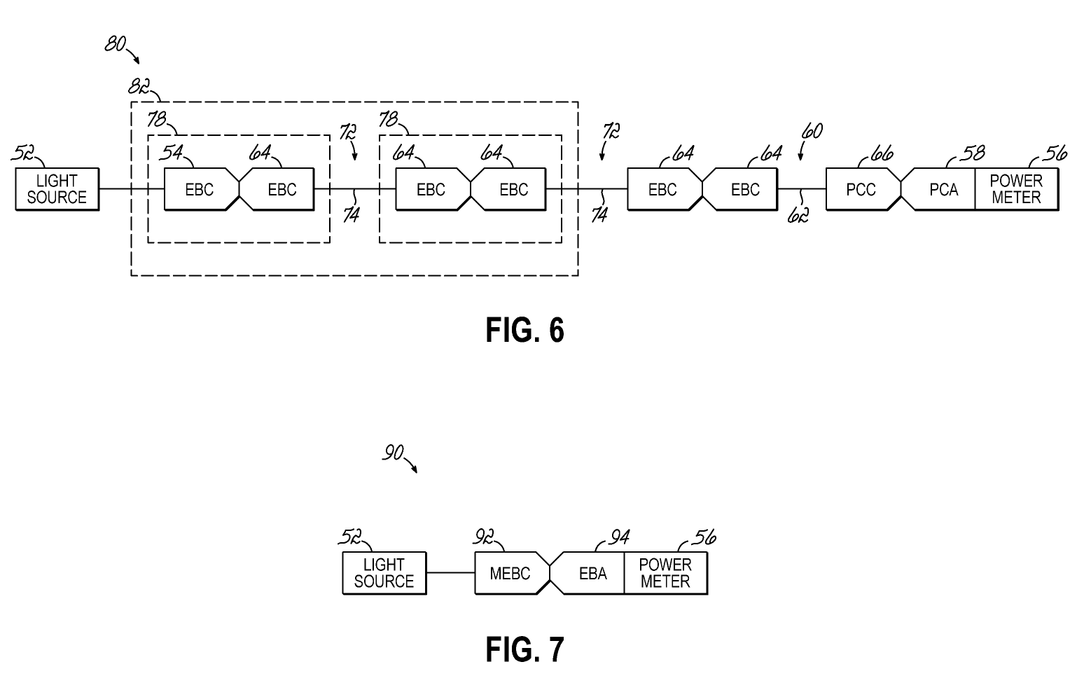

FIG. 6 depicts an exemplary double-ended test setup 80 that includes the components of the single-ended test setup 70 with the addition of yet another fiber optic cable assembly 72 between the fiber optic cable assembly 72 being tested and the expanded beam connector 64 of reference fiber optic cable assembly 60. The double-ended characteristic test is a system test that may be used to measure the characteristic of optical link 82. That is, the test may measure the characteristic of both optical links 78, e.g., each optical connection to the fiber optic cable assembly 72. This may include any loss in the fiber optic cable 74, although the fiber optic cable insertion loss is typically minimal. As with the single-ended test, the characteristic of the optical link 82 may be determined by measuring the test characteristic between the light source 52 and power meter 56, and comparing the test characteristic to the baseline characteristic.

The exemplary test setups depicted by FIGS. 4-6 have several drawbacks. One is the need for the reference fiber optic cable assembly 60, which is a custom part that adds significant expense. The reference fiber optic cable assembly 60 may also introduce multimode signals that could impact the accuracy of the measurements due to its large core diameter. Thus, the above test setups and methods of optical measurement may not be practical for widespread implementation. Additionally, the method may have accuracy limitations when measuring connectors having polarities other than a straight polarity.

Advantageously, the improved characteristic measurement techniques described below enable measurement of optical links including expanded beam connectors without the need for a custom reference fiber optic cable assembly 60. Instead, an expanded beam connector adapter is used at the power meter 56. This enables use of a reference fiber optic cable assembly that is terminated by expanded beam connectors 64 at each end rather than the physical contact connector 66 that is operatively coupled to the physical contact connector adapter 58. In some embodiments, one or more of the expanded beam connectors in the test setup may be modified by adding a window to the cassette 22. However, this modification does not affect the compatibility of the modified expanded beam connector with other unmodified expanded beam connectors.

FIG. 7 depicts an exemplary baseline test setup 90 for testing an optical link including an expanded beam connector in accordance with the above described modifications. The baseline test setup 90 includes the light source 52 and power meter 56 of baseline test setup 50. However, the light source 52 is operatively coupled to a modified expanded beam connector 92, and the power meter 56 includes an expanded beam connector adapter 94 configured to accept the modified expanded beam connector 92. As with the baseline test setup 50 of FIG. 4, the baseline test setup 90 may be used to measure a baseline characteristic between the light source 52 and power meter 56 for later determining one or more characteristics of an optical link under test.

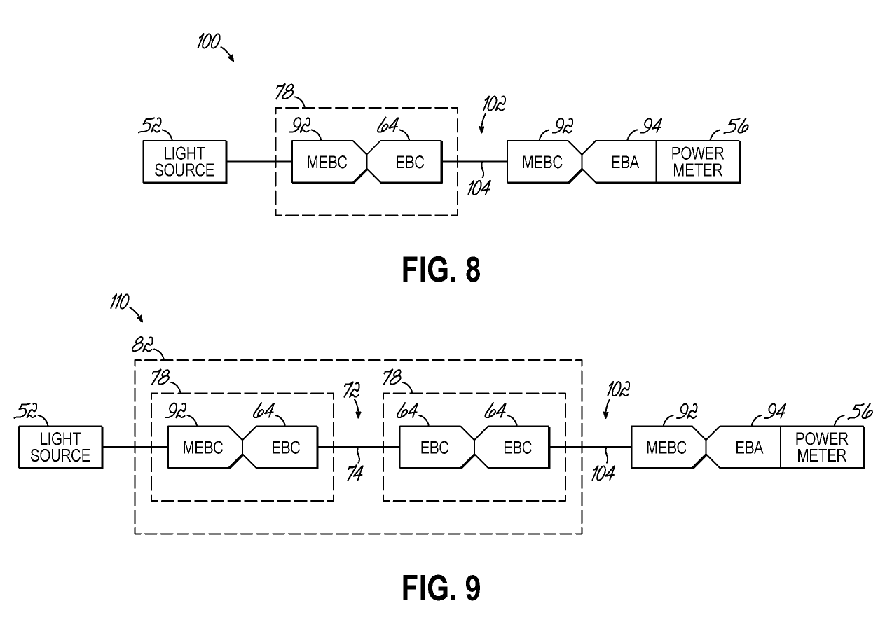

FIG. 8 depicts an exemplary single-ended test setup 100 that includes the components of the baseline test setup 90 with the addition of a reference fiber optic cable assembly 102. The reference fiber optic cable assembly 102 may include a fiber optic cable 104 that is terminated at one end by an unmodified expanded beam connector 64 and at the other end by a modified expanded beam connector 92. The reference fiber optic cable assembly 102 may be inserted between the reference modified expanded beam connector 92 and the expanded beam connector adapter 94. The characteristic of the optical link 78 may then be determined by measuring the test characteristic between the light source 52 and power meter 56, and comparing the test characteristic produced by single-ended test setup 100 to the baseline characteristic of baseline test setup 90.

The optical connection measured by single-ended test setup 100 includes the optical connection between the modified expanded beam connector 92 of light source 52 and the expanded beam connector 64 of the reference fiber optic cable assembly 102. This type of measurement may require the reference fiber optic cable assembly 102 to have a modified expanded beam connector 92 to interface with the expanded beam connector adapter 94 on the power meter side of the cable assembly 102. Because standard fiber optic cable assemblies may not be modified under normal conditions, and modification of cable assemblies which are to be shipped to customers may not be feasible, single-ended test setup 100 may not be applicable for manufacturer testing of high volume products. However, the single-ended test setup 100 depicted by FIG. 8 may be used for low quantity products in which modification and replacement of the cassette 22 would be manageable, such as in testing and qualification, or for laboratory use.

FIG. 9 depicts an exemplary double-ended test setup 110 that includes the components of the single-ended test setup 100 with the addition of another fiber optic cable assembly 72 inserted between the modified expanded beam connector 92 of light source 52 and the expanded beam connector 64 of the reference fiber optic cable assembly 102. As described above for the double-ended test setup 80 of FIG. 6, the double-ended characteristic test is a system test that measures a characteristic of the optical link 82. That is, the test measures the characteristic of both optical links 78 as well as any contribution by the fiber optic cable 74. As with the single-ended test, the characteristic of the optical link 82 may be determined by measuring the test characteristic between the light source 52 and power meter 56, and comparing the test characteristic to the baseline characteristic.

The double-ended test setup 110 of FIG. 9 may be most useful for system testing. In this scenario, the fiber optic cable assembly 72 under test may be inserted between the modified expanded beam connector 92 of light source 52 and the expanded beam connector 64 of reference fiber optic cable assembly 102. Thus, the power meter side of the fiber optic cable assembly 72 under test is coupled to the power meter 56 through the reference fiber optic cable assembly 102. Accordingly, double-ended test setup 110 of FIG. 9 may be referred to as a system test or double ended test, since the entire optical link 82 is measured. Advantageously, the double-ended test setup 110 does not require any modifications to the cassettes 22 (FIG. 2) of the expanded beam connectors 64 of the fiber optic cable assembly 72 under test. That is, only the reference fiber optic cable assembly 102 needs to include at least one modified expanded beam connector 92 to interface with the expanded beam connector adapter 94. Accordingly, the double-ended test setup 110 may be suitable for testing in high-volume manufacturing scenarios in which the expanded beam connectors 64 of the product being tested cannot be modified.

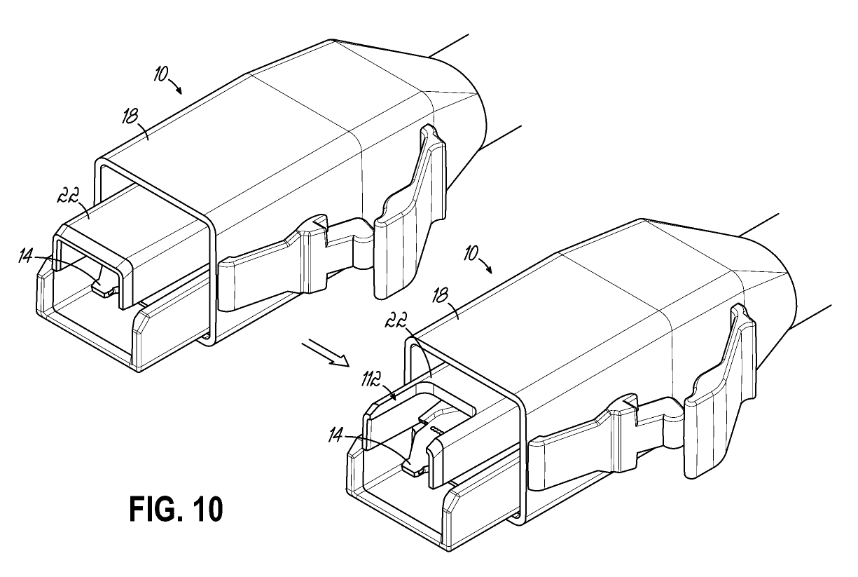

FIG. 10 depicts an expanded beam connector 10 before modification (left) and after modification (right). As can be seen, the modification entails opening a window 112 in the cassette 22 so that the expanded optical beams 36 emitted from the ferrule 14 can escape from the modified expanded beam connector 92. Although the depicted embodiment shows a relatively large portion of the cassette 22 being removed, the same result may be achieved in alternative embodiments having smaller or differently shaped windows. For example, a correctly positioned slit, a plurality of individual circular holes (e.g., one for each optical fiber 16), or any other suitable window that prevents the cassette 22 from obstructing the expanded optical beams 36. The window 112 or windows 112 may be added by machining an existing cassette 22, or by fabricating the cassette 22 to have the window(s) 112 (e.g., at the injection molding stage).

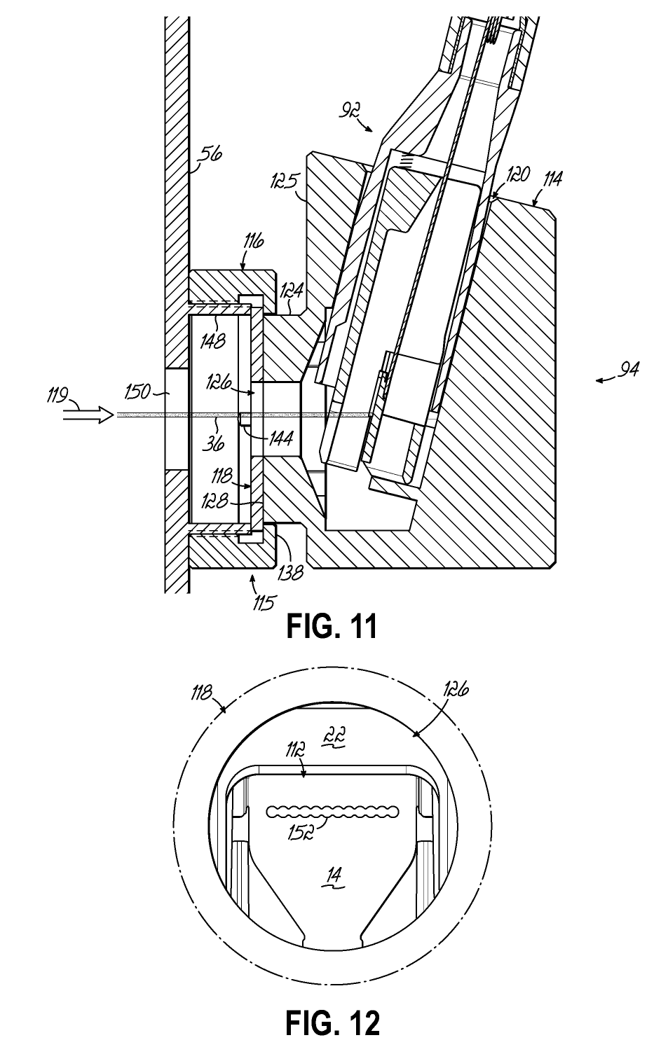

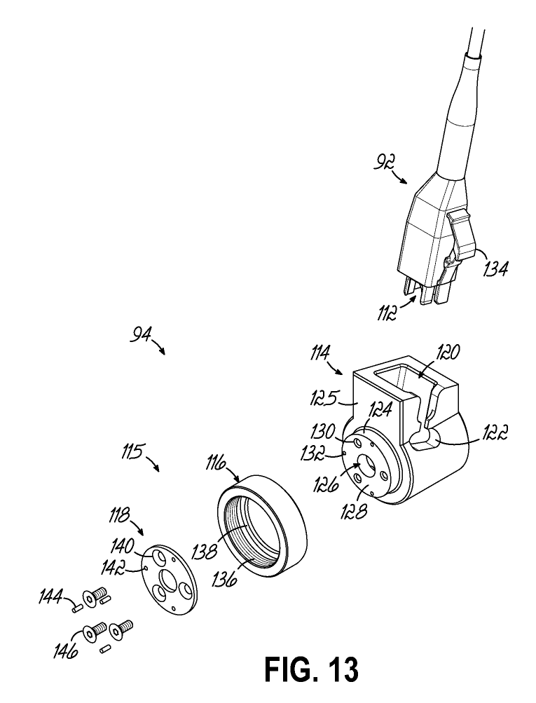

FIGS. 11-13 depict an exemplary embodiment of the expanded beam connector adapter 94 that includes a body 114 and a coupler 115 for coupling the adapter 94 to the power meter 56. FIG. 11 presents a cross-sectional view of the expanded beam connector adapter 94 attached to the power meter 56 and mated to a modified expanded beam connector 92, FIG. 12 presents a front-view looking into the expanded beam connector adapter 94 from the vantage point indicated by single headed arrow 119 in FIG. 11, and FIG. 13 presents an exploded view of the expanded beam connector adapter 94.

As best shown by FIGS. 11 and 13, the coupler 115 may include a cylindrical retaining collar 116 and a circular retaining plate 118. The body 114 may include an open-ended connector cavity 120, a retention slot 122 adjacent to the connector cavity 120, a cylindrical boss 124 that projects outward from a meter-facing outer surface 125 of body 114, and an optical port 126 centered in the boss 124 that intersects the connector cavity 120. The optical port 126 may have a circular cross-section that defines a ring-shaped face 128 on the boss 124. The face 128 of boss 124 may include one or more threaded bores 130 (e.g., three threaded bores 130) and one or more locating holes 132 (e.g., three locating holes 132) arranged circumferentially around the optical port 126. The connector cavity 120 may be configured to receive and position the modified expanded beam connector 92 so that optical beams 36 emitted from the ferrule 14 thereof are transmitted through the optical port 126. The retention slot 122 may be configured to engage a coupling mechanism 134 of modified expanded beam connector 92 to hold the connector in place when it is fully seated in the connector cavity 120.

The retaining collar 116 may include a threaded inner surface 136 and a shoulder 138. The inner surface 136 may have a diameter equal to or slightly greater than the diameter of the retaining plate 118. The shoulder 138 may define an aperture with a diameter smaller than the diameter of the retaining plate 118 and equal to or larger than the outer diameter of the boss 124. The retaining plate 118 may include a plurality of counter-sunk holes 140 (e.g., three counter-sunk holes 140) and a plurality of alignment holes 142 (e.g., three alignment holes 142). The counter-sunk holes 140 and alignment holes 142 may be positioned on the retaining plate 118 so that, when the retaining plate 118 is positioned on the face 128 of boss 124, the counter-sunk holes 140 and alignment holes 142 can be aligned with the threaded bores 130 and locating holes 132, respectively.

The retaining collar 116 may be operatively coupled to the body 114 of expanded beam connector adapter 94 by placing the retaining collar 116 over the boss 124 with the shoulder 138 facing the body 114 of expanded beam connector adapter 94. The retaining plate 118 may then be attached to the face 128 of boss 124 by inserting an aligning pin 144 into each locating hole 132, placing the retaining plate 118 on the face 128 so that each aligning pin is received by a respective alignment hole 142, and installing a threaded fastener 146 (e.g., a flat-head screw) through each of the counter-sunk holes 140 and into the threaded bores 130. The expanded beam connector adapter 94 may then be operatively coupled to the power meter 56 (e.g., to an integrating sphere or polarity detector of the power meter 56) by engaging the retaining collar 116 with a threaded barrel 148 of power meter 56.

As best shown by FIGS. 11 and 12, the retaining collar 116 and threaded barrel 148 may be configured to position the expanded beam connector adapter 94 so that the optical port 126 thereof is aligned with an optical port 150 of the power meter 56. The expanded beam connector adapter 94 may be configured so that when the modified expanded beam connector 92 is operatively coupled to the expanded beam connector adapter 94, one or more optical windows 152 of ferrule 14 are generally aligned with the optical port 150 so that optical beams 36 emitted from the ferrule 14 are transmitted through the optical port 150 and into the power meter 56. Optical ports and windows may be considered as being aligned if optical beams can propagate between the aligned ports/windows unimpeded.

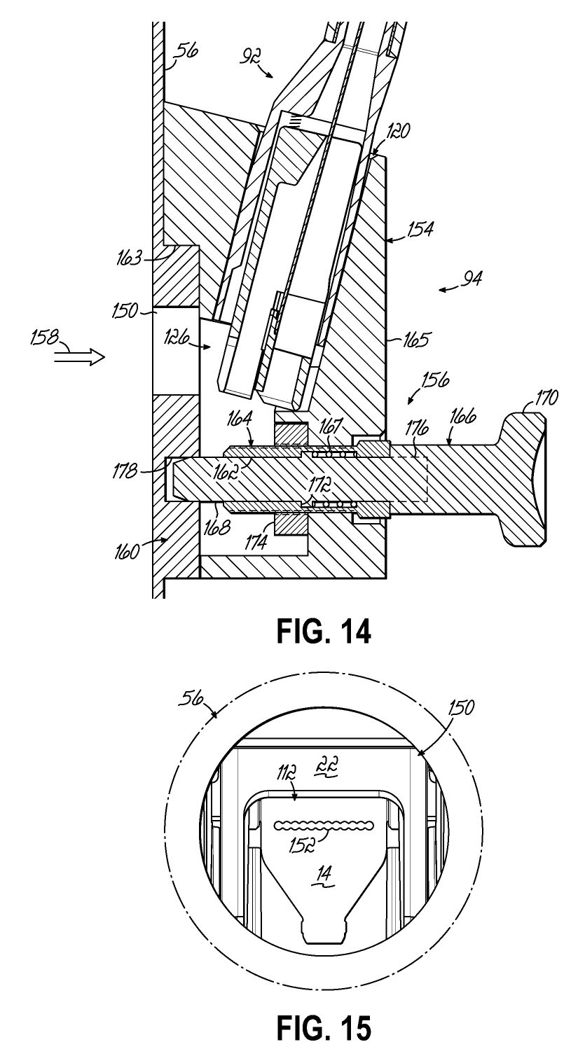

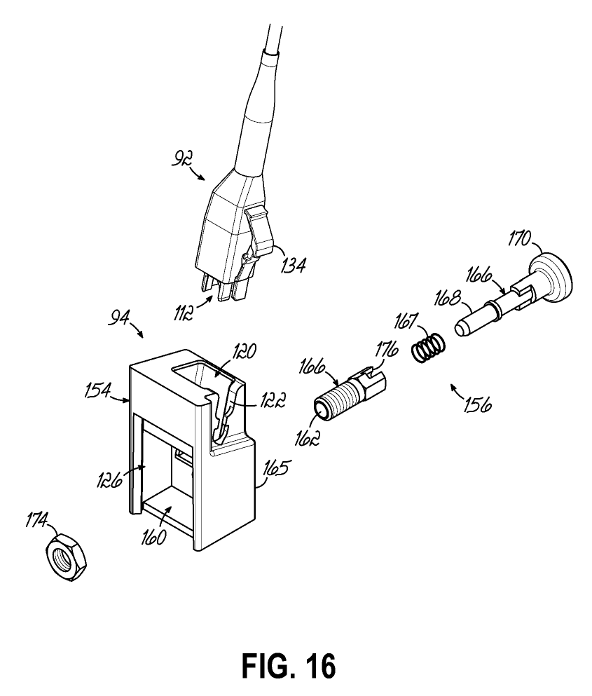

FIGS. 14-16 depict another exemplary embodiment of the expanded beam connector adapter 94 that includes a body 154 and an indexing plunger assembly 156. FIG. 14 presents a cross-sectional view of the expanded beam connector adapter 94 attached to the power meter 56 and mated to a modified expanded beam connector 92, FIG. 15 presents a front-view looking into the expanded beam connector adapter 94 from the vantage point indicated by single headed arrow 158 of FIGS. 14, and 16 presents an exploded view of the expanded beam connector adapter 94.

As best shown by FIGS. 14 and 16, the body 154 includes the connector cavity 120, retention slot 122, and optical port 126, as well as a lower cavity 160, a bore 162, and a coupler in the form of an integral retaining collar 163. The lower cavity 160 may be open to the power meter side of body 154, and the bore 162 may connect the lower cavity 160 to an outer surface 165 of body 154 that faces away from the power meter 56.

The indexing plunger assembly 156 may include a threaded sleeve 164 and a plunger 166 having a pin 168 and a keyed knob 170. The pin 168 may be held captive in the threaded sleeve 164 so that movement of the plunger 166 is restricted to a predetermined range. The indexing plunger assembly 156 may further include an elastic member (e.g., a spring – not shown) that biases the plunger 166 toward a forward position within its range of motion.

The bore 162 may be configured to receive the threaded sleeve 164 and include a counter sink. The threaded sleeve 164 may include a shoulder 172 having a diameter larger than that of the main shaft of bore 162 but less than that of the counter-sunk portion of bore 162. The indexing plunger assembly 156 may be inserted into the bore 162 and held in place by a retaining nut 174 that sandwiches a portion of the body 154 proximate to the bore 162 between itself and the shoulder 172 of threaded sleeve 164.

To couple the expanded beam connector adapter 94 to the power meter 56, the indexing plunger assembly 156 may be placed into lock-out position in which the plunger 166 is kept in a retracted position by rotating the knob 170 (e.g., by 90 degrees) after being retracted. The threaded sleeve 164 may include a notch 176 that allows the plunger 166 to move into the forward position when the knob 170 is rotated into an unlocked position, and that keeps the plunger 166 in the rearward or locked-out position when the knob 170 is rotated into a locked position.

While the indexing plunger assembly 156 is in the lock-out position, the retaining collar 163 of expanded beam connector adapter 94 may be placed on the threaded barrel 148 of power meter 56 and the expanded beam connector adapter 94 rotated to engage the retaining collar 163 with the threaded barrel 148. Once the expanded beam connector adapter 94 is suitably engaged with the power meter 96, the plunger 166 may be taken out of the lock-out position by rotating the knob 170. The indexing pin 168 may then move into the forward position and engage an indexing hole 178 in the power meter 56 to prevent further rotation of the expanded beam connector adapter 94 relative to the power meter 56.

As described above with respect to FIGS. 11-13, the connector cavity 120 may be configured to receive and position the modified expanded beam connector 92 so that optical beams 36 emitted from the ferrule 14 thereof are transmitted towards the optical port 150 of power meter 56. The retention slot 122 may be configured to engage the coupling mechanism 134 of modified expanded beam connector 92 to hold the connector in place when it is fully seated in the connector cavity 120.

As best shown by FIGS. 14 and 16, the retaining collar 163 may be configured to position the modified expanded beam connector 92 so that the optical port 126 thereof is aligned with the optical port 150 of power meter 56. The expanded beam connector adapter 94 may be configured so that when the modified expanded beam connector 92 is operatively coupled to the expanded beam connector adapter 94, the optical window 152 of ferrule 14 is generally aligned with the optical port 150 of power meter 56 so that optical beams 36 emitted from the window 152 are transmitted through the optical port 150 and into the power meter 56.

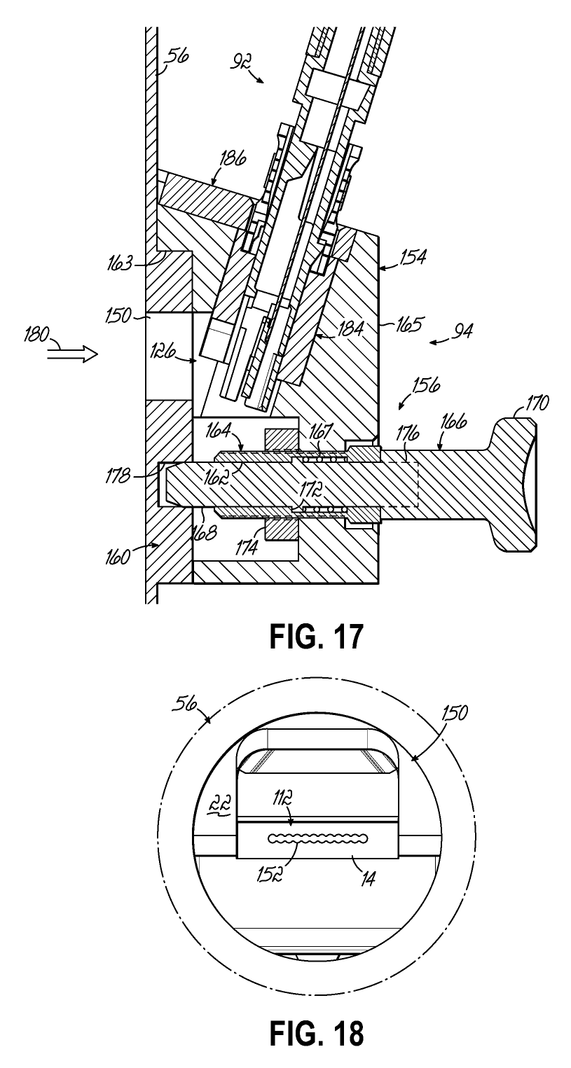

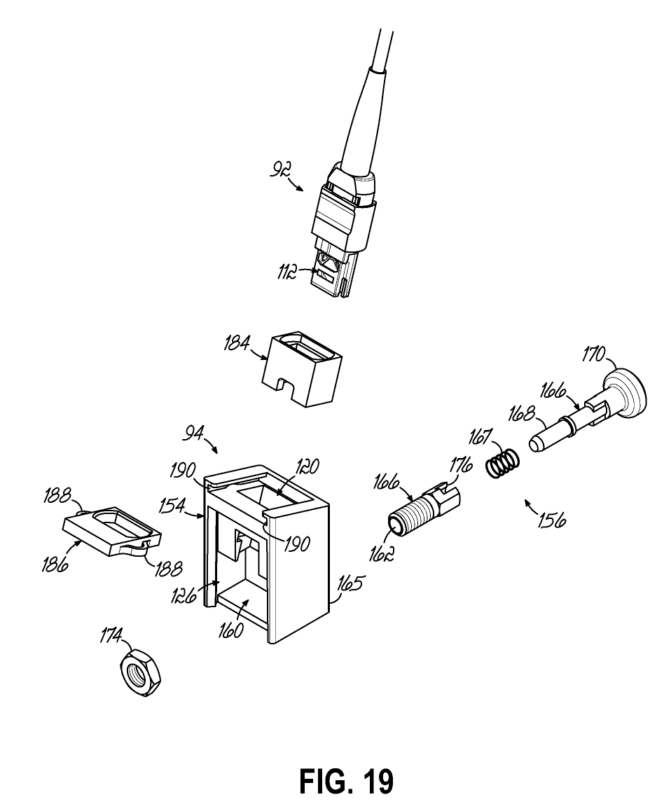

FIGS. 17-19 depict another exemplary embodiment of the expanded beam connector adapter 94 that includes the body 154 and indexing plunger assembly 156. FIG. 17 presents a cross-sectional view of the expanded beam connector adapter 94 attached to the power meter 56 and mated to a modified expanded beam connector 92 having a form factor similar to that of an MTP/MPO connector, FIG. 18 presents a front-view looking into the expanded beam connector adapter 94 from the vantage point indicated by single headed arrow 180 of FIG. 17, and FIG. 19 presents an exploded view of the expanded beam connector adapter 94.

As best shown by FIGS. 17 and 19, the body 154 includes the connector cavity 120, optical port 126, lower cavity 160, bore 162, and integral retaining collar 163. In the depicted embodiment, the connector cavity 120 is configured to receive a connector fitting 184 and fitting retainer 186 rather than directly receive the modified expanded beam connector 92. The connector fitting 184 may be configured to receive the modified expanded beam connector 92 and may be held in place within the connector cavity 120 by the fitting retainer 186. The fitting retainer 186 may include one or more tabs 188 each configured to be received by a corresponding slot 190 in the body 154 of expanded beam connector adapter 94. The fitting retainer 186 may be used to retain the connector fitting 184 in the connector cavity 120 by engaging the tabs 188 with the slots 190 and sliding the fitting retainer 186 into place. The connector fitting 184 may be configured to engage the modified expanded beam connector 92 and hold the connector in place when it is fully seated in the connector fitting 184. Advantageously, the ability to swap out connector fittings 184 may enable the expanded beam connector adapter 94 to be used with different types of expanded beam connectors by simply selecting a connector fitting 184 configured to receive the type of modified expanded beam connector 92 being tested.

The expanded beam connector adapter 94 may be coupled to the power meter 56 in essentially the same manner as described above with respect to FIGS. 14-16, and the connector cavity 120 and connector fitting 184 may be configured to receive and position the modified expanded beam connector 92 so that optical beams 36 emitted from the ferrule 14 thereof are transmitted towards the optical port 150 of power meter 56. As best shown by FIGS. 17 and 19, the retaining collar 163 may be configured to position the expanded beam connector adapter 94 so that the optical port 126 is aligned with the optical port 150 of power meter 56. The expanded beam connector adapter 94 may be configured so that when expanded beam connector 10 is operatively coupled to the expanded beam connector adapter 94, an optical window 152 of ferrule 14 is generally aligned with the optical port 150 so that optical beams 36 emitted from the window 152 are transmitted through the optical port 150 and into the power meter 56.

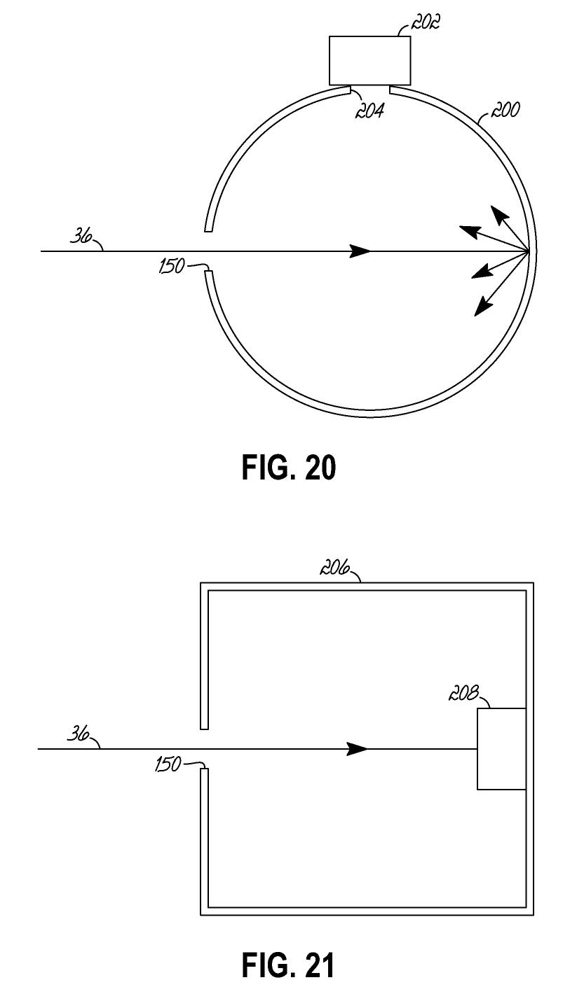

Power meters 56 configured to measure optical characteristics may include (or be coupled to) an integrating sphere that receives the optical beam 36 being measured. In contrast, power meters 56 configured to measure polarity may include (or be coupled to) a polarity detector that receives the optical beam 36. FIG. 20 depicts an exemplary integrating sphere 200. The integrating sphere 200 may include an inner surface coated with a diffuse reflective coating, and may receive the optical beam 36 through the optical port 150. Optical beams 36 entering the integrating sphere 200 may strike the reflective surface and undergo multiple diffuse reflections so that the light is uniformly dispersed on the inner surface of the integrating sphere 200. The resulting integrated light level is thus proportional to the amount of light provided by the optical beam 36 and can be measured by a photo detector 202 operatively coupled to the integrating sphere 200, e.g., via a sensor optical port 204 offset from the input optical port 150.

FIG. 21 depicts an exemplary polarity detector 206 including a camera 208 that images the optical beams 36 as they enter the power meter 56 through the optical port 150. The camera 208 may include a lens and image sensor (not shown) configured so that the camera 208 is focused on an object plane proximate to the optical port 150. Thus, images captured by the camera 208 may show the positions of optical beams 36 as they enter the optical port 150.

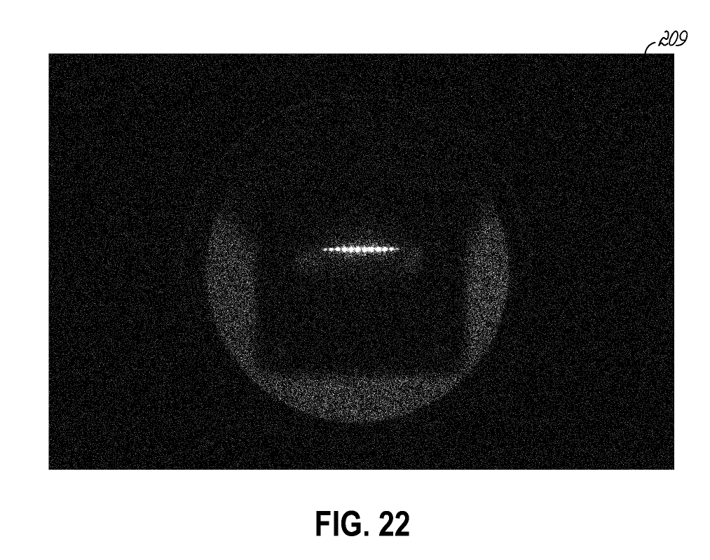

FIG. 22 depicts an exemplary image 209 of the optical port 150 captured by a camera 208 showing a ferrule 14 with all twelve optical fibers illuminated. To measure polarity, a light source may be routed (e.g., by an optical switch) into each optical fiber 16 one by one, while the camera 208 detects the positions of light coming out of connector. The polarity detector 206 may check whether the expected position matches the actual position of the optical beam 36 in the image. If the polarity is correct, an operator may move the optical link under test to check some other characteristic, such as insertion loss. Incorrect polarity may be caused by a broken fiber or switched channels, for example. Thus, by capturing an image rather than diffused light, the camera 208 may allow the power meter 56 to determine which optical fiber 16 is the source of an optical beam 36 based on the position of the optical beam 36 in the image captured by the camera 208.

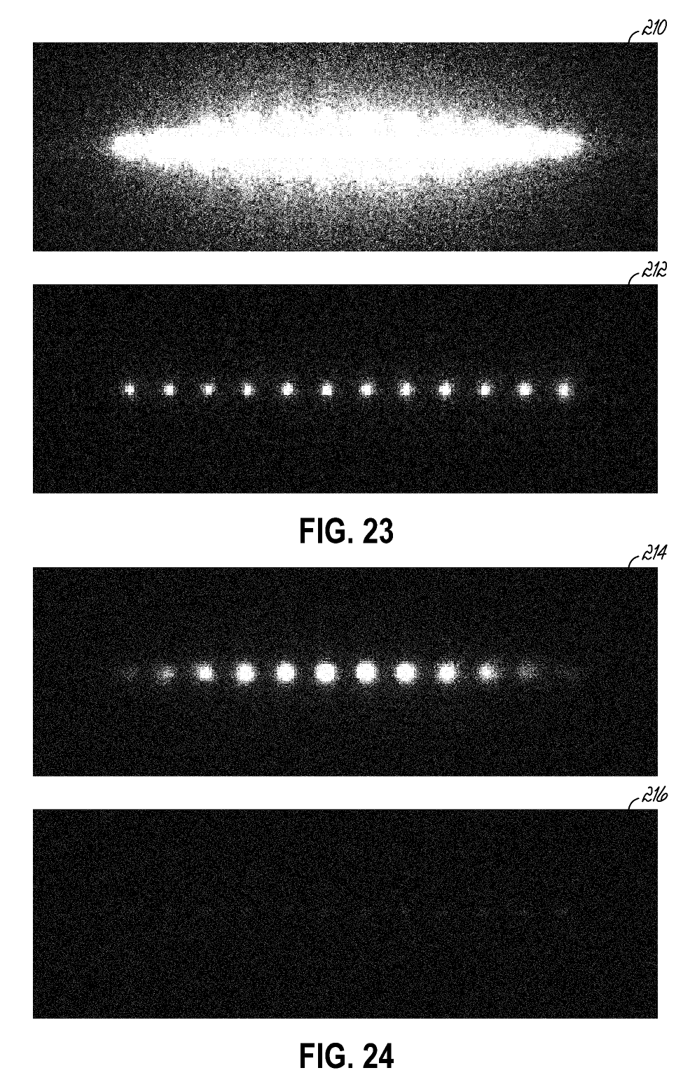

One problem with standard power meters 56 is that the camera 208 is configured to capture optical beams 36 from a physical contact connector 66, and may improperly expose the optical beams 36 received from the modified expanded beam connector 92. By way of example, FIG. 23 depicts an image 210 obtained with an expanded beam connector and an image 212 obtained with a physical contact connector 66. As can be seen, the optical beams 36 in image 210 are greatly overexposed and are difficult to distinguish from one another. The optical beams 36 in image 210 also vary in brightness across the expanded beam connector 10.

As another example, FIG. 24 depicts an image 214 obtained with an expanded beam connector and an image 216 obtained with a physical contact connector for which the exposure has been reduced to optimize the image 214 with the expanded beam connector. As can be seen, the optical beams 36 of image 214 are not all visible due to the variation in brightness, and the optical beams 36 of image 216 are barely visible or not visible at all.

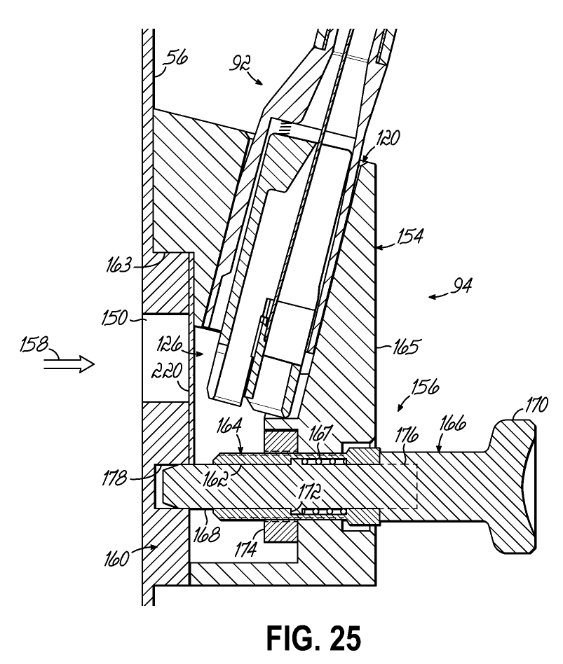

FIG. 25 depicts cross-sectional view of another embodiment of the expanded beam connector adapter 94 similar to the embodiment in FIG. 14 that further includes an imaging screen 220. The imaging screen 220 may include one or more of an optical diffuser (e.g., a ground glass screen), a lens (e.g., a Fresnel lens), and a filter (e.g., a neutral density filter) positioned proximate to the optical port 126 so that at least a portion of the imaging screen 220 is within a field of view of the camera 208 of power meter 56. The imaging screen 220 may thereby provide a surface that can be imaged by the camera 208, i.e., a surface that is visible through the optical port 126 of expanded beam connector adapter 94.

The imaging screen 220 may be positioned in the expanded beam connector adapter 94 so that the portion within the field of view of the camera 208 is also in the optical path each expanded optical beam 36 emitted by the modified expanded beam connector 92. Each optical beam 36 incident on the imaging screen 220 may generate a spot thereon that can be captured by the camera 208 of power meter 56. The resulting images of the spots captured by the camera 208 may have a more consistent brightness across images formed directly from the optical beams 36, thereby improving the ability of the power meter 56 to measure the polarity of the fiber optic link under test as compared to test setups lacking an imaging screen 220. The imaging screen 220 may also be configured to modify the brightness of the spots so that the same exposure can be used with both expanded beam and physical contact connectors.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

What is claimed is:

1. A system for testing optical links including an expanded beam connector, comprising:
an expanded beam connector adapter including:
a body having a connector cavity configured to receive the expanded beam connector and an optical port that intersects the connector cavity at an angle such that, when the expanded beam connector is engaged with the connector cavity, an optical beam emitted laterally from the expanded beam connector passes through the optical port; and
a coupler configured to couple the expanded beam connector adapter to a power meter so that the optical port of the body is aligned with an optical port of the power meter.

2. The system of claim 1, further comprising:
a fitting configured to receive the expanded beam connector, wherein the fitting is removably positioned in the connector cavity.

3. The system of claim 2, further comprising:
a retainer configured to engage the body of the expanded beam connector adapter and retain the fitting in the connector cavity.

4. The system of claim 1, further comprising:
an indexing plunger assembly operatively coupled to the body of the expanded beam connector adapter and configured to selectively engage the power meter,
wherein the indexing plunger assembly prevents rotation of the expanded beam connector adapter relative to the power meter when engaged and allows rotation of the expanded beam connector adapter relative to the power meter when not engaged.

5. The system of claim 1, further comprising:
an imaging screen positioned in the body of the expanded beam connector adapter so that, when the expanded beam connector is engaged with the connector cavity, at least a portion of the imaging screen is both visible through the optical port of the body and in an optical path of the optical beam emitted from the expanded beam connector.

6. The system of claim 5, wherein the imaging screen includes one or more of an optical diffuser, a lens, and a filter.

7. The system of claim 1, further comprising the expanded beam connector, wherein the expanded beam connector includes a ferrule that emits the optical beam and a cassette that positions the ferrule within the expanded beam connector, and the cassette includes an optical window through which the optical beam passes when the expanded beam connector is engaged with the connector cavity.

8. The system of claim 7, further comprising:
a light source, wherein the expanded beam connector terminates a fiber optic cable operatively coupled to the light source.

9. The system of claim 7, further comprising:
a reference fiber optic cable assembly that includes the expanded beam connector.

10. The system of claim 9, wherein the expanded beam connector is a first expanded beam connector operatively coupled to the power meter by the expanded beam connector adapter, the reference fiber optic cable assembly includes a second expanded beam connector, and further comprising:
an optical link under test that operatively couples a light source to the second expanded beam connector of the reference fiber optic cable assembly.

11. A method of testing optical links including an expanded beam connector, comprising:
providing an expanded beam connector adapter including a connector cavity and an optical port;
configuring the connector cavity to receive the expanded beam connector; and
configuring the optical port to intersect the connector cavity at an angle such that, when the expanded beam connector is engaged with the connector cavity, an optical beam emitted laterally from the expanded beam connector passes through the optical port.

12. The method of claim 11, wherein configuring the connector cavity to receive the expanded beam connector comprises:
configuring a fitting to receive the expanded beam connector; and
positioning the fitting into the connector cavity.

13. The method of claim 12, further comprising:
retaining the fitting in the connector cavity by engaging a retainer with a body of the expanded beam connector adapter.

14. The method of claim 11, further comprising:
operatively coupling an indexing plunger assembly to a body of the expanded beam connector adapter; and
configuring the indexing plunger assembly to selectively engage a power meter so that the indexing plunger assembly prevents rotation of the expanded beam connector adapter relative to the power meter when engaged and allows rotation of the expanded beam connector adapter relative to the power meter when not engaged.

15. The method of claim 11, further comprising:
positioning an imaging screen in a body of the expanded beam connector adapter so that, when the expanded beam connector is engaged with the connector cavity, at least a portion of the imaging screen is both visible through the optical port and in an optical path of the optical beam emitted from the expanded beam connector.

16. The method of claim 11, wherein the expanded beam connector includes a ferrule that emits the optical beam and a cassette that positions the ferrule within the expanded beam connector, and further comprising:
defining an optical window in the cassette, wherein the optical window is configured so that the optical beam passes through the optical window when the expanded beam connector is engaged with the connector cavity.

17. The method of claim 11, further comprising:
terminating one end of a fiber optic cable with the expanded beam connector; and
operatively coupling another end of the fiber optic cable to a light source.

18. The method of claim 11, further comprising:
terminating one end of a reference fiber optic cable assembly with the expanded beam connector.

19. The method of claim 18, wherein the expanded beam connector is a first expanded beam connector, and further comprising:
operatively coupling the first expanded beam connector to a power meter with the expanded beam connector adapter;
terminating another end of the reference fiber optic cable assembly with a second expanded beam connector; and
operatively coupling one side of an optical link under test to a light source and another side of the optical link under test to the second expanded beam connector of the reference fiber optic cable assembly.

20. An expanded beam connector, comprising:
a connector housing;
a ferrule that emits an optical beam laterally therefrom;
a cassette that positions the ferrule within the connector housing and includes an optical window through which the optical beam passes when the expanded beam connector is not engaged with another expanded beam connector.
